(19) United States
(12) Patent Application Publication
(10) Pub. No.: US 2003/0074133 A1
(43) Pub. Date: Apr. 17, 2003

(54) TripKing-a preference-based, date, time and route sensitive road trip planning/itinerary software/web application

(76) Inventors: Richard McKinley, Marblehead, MA (US); Christopher John Stockwell, Marblehead, MA (US); Adam Gautier, Boston, MA (US)

Correspondence Address: Richard McKinley, 25 Heritage Way, Marblehead, MA, 01945, US

(21) Appl. No.: 09/977,843

(22) Filed: Oct. 16, 2001

(51) Int. Cl. G01C 21/26

(52) U.S. Cl. 701/202; 701/209

(57) ABSTRACT

The road trip planning application is a software application comprised of traveler preference collection, a date, time and route sensitive search engine, the ability to do the search for events/locations a specified distance off of a specified or calculated route. Also included is the ability to display the search results in a date, time and route sensitive manner (trip itinerary) and to print the resulting itineraries.

### CROSS-REFERENCED TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention is a software application that can be either Web based or resident on a local computer. Other mapping and mapping search applications work on point (vicinity searches) searches and do not return search results along a certain line/route. They focus on maps and directions as opposed to overlaying these capabilities with user preferences to create trips or itineraries in a date, time and route sensitive manner.

### BRIEF SUMMARY OF THE INVENTION

The TripKing application solves the problems identified above. It provides line search results based on searching for preference-based stop locations and events along a designated/calculated route. These locations are presented in an itinerary format based on date, time and route.

The primary motivation of this application is to provide the first comprehensive application for planning all aspects of a road trip. Other objects, features and advantages of the present application will become apparent to those skilled, through the description, claims herein.

### BRIEF DESCRIPTION OF THE SEVERAL VIEWS OF THE DRAWING

Not Applicable

### DETAILED DESCRIPTION OF THE INVENTION

The TripKing application uniquely allows the planning of itineraries for automobile travel also known as road-trips. The uniqueness of this system lies in the ability of the system to align geography-based information with time. In essence this innovation for the first time allows a user to plan where they are going to be and when. Although, this information is available to anyone without TripKing this is the first time that the data sets have been combined using a set of unique algorithms. The two primary algorithms that make up the TripKing application are known as:

Point Search:

The Point Search Algorithm allows a user to find any intermediate point along their chosen route using the variable of time. With this algorithm a user can supply a time (12:00 PM) for lunch and locate the exact or approximate geographic position on the route. This ability allows the TripKing application to find appropriate destinations (i.e., restaurants, lodging) to be added to the trip itinerary.

The Point Search Algorithm works as a typical input/process/output software function. The input for the algorithm is:

a Start Point (geographic based Latitude/Longitude point)

End Point (geographic based Latitude/Longitude point)

Departure Time (Integer of milliseconds since the epoch 12:00:00:00 AM Jan. 1, 1970)

Route (a list of intermediate geographic based Latitude/Longitude points)

Speed (an average speed)

Search Time (Integer of milliseconds since the epoch 12:00:00:00 AM Jan. 1, 1970)

The process of the algorithm is to start at the Start Point and move along the route calculating the distance traveled. With the distance combined with speed a time can be calculated along all points of the Route. The two points of the Route that contain the Search Time are then used to extrapolate the higher precision estimate of the geographic based Latitude/Longitude point for the Search Time which is returned as the algorithm's output. The output therefore corresponds to a specific geographic point in time within the trip itinerary.

Line Path Search:

The Line Path Search Algorithm allows a user to define a space in time along their chosen route. With this algorithm a user can supply a time slice (12:30 PM to 6:00 PM) after lunch but before dinner and locate a geographic space on the route. This ability allows users to discover a “range” of possible destinations that can be added to the trip itinerary.

The Line Search Algorithm works as a typical input/process/output software function. The input for the algorithm is:

Start Point (geographic based Latitude/Longitude point)

End Point (geographic based Latitude/Longitude points)

Departure Time (Integer of milliseconds since the epoch 12:00:00:00 AM Jan. 1, 1970)

Route (a list of intermediate geographic based Latitude/Longitude point)

Speed (an average speed)

Search Time Begin (Integer of milliseconds since the epoch 12:00:00:00 AM Jan. 1, 1970)

Search Time End (Integer of milliseconds since the epoch 12:00:00:00 AM Jan. 1, 1970)

The process of the algorithm is to start at the Start Point and move along the route calculating the distance traveled. With the distance combined with speed a time can be calculated along all points of the Route. The two points of the Route that contain the Search Time Begin are then used to extrapolate the higher precision estimate of the geographic based Latitude/Longitude point for the Search Time Begin which is added to a list that is the algorithm's output. The route is followed adding each intermediate point to the output list until the End Point or the Search Time End is found. The output of the algorithm is a list of geographic based Latitude/Longitude points that apply a specific geographic region to a moment of time in the trip itinerary.

The process by which a user plans a road-trip is simple by use of these two algorithms.

1.) The user provides two points (start and end) of an itinerary. (EXAMPLE: Boston, Mass. to Ocean Springs, Miss.)

2.) The user provides a departure time from the start point. (EXAMPLE: 8:00 AM Jan. 1, 2000)

3.) The trip route is generated.

4.) The average speed of the route is calculated.

5.) The arrival time for end is calculated based on departure time and speed.

6.) The user can then search for intermediate destinations (i.e., dining, lodging, things to see and do . . . ) via time using the Point Search Algorithm or the Line Path Search Algorithm.

7.) The user is given destination choices that match the user's criteria.

8.) The user selects a destination.

9.) The route/trip between the start and intermediate destination is generated.

10.) The average speed of the route between the start and intermediate destination is calculated.

11.) The destination time for the intermediate destination is calculated based on departure time and speed.

12.) The user provides a departure time for the intermediate destination.

13.) The route/trip between the intermediate destination and end is generated.

14.) The average speed of the route between the intermediate destination and end is calculated.

15.) The arrival time for the end is calculated based on departure time and speed.

16.) The process 6-15 is repeated for each desired destination until the user decides the trip itinerary is complete.

It is with these two algorithms that TripKing has created a unique and useful application. For the first time users have the ability to create road-trip itineraries that are accurately based on the time(s) chosen by the user.

We claim our invention is:

1. A road trip planning software application comprising: (a) preference-based location search engine.

2. The preference-based search engine of claim 1 wherein the search engine will handle date sensitive events/location searches.

3. The preference-based search engine of claim 1 wherein the search engine will handle time sensitive events/location searches.

4. The preference-based search engine of claim 1 wherein the search engine will handle route sensitive events/location searches.

5. The preference-based search engine of claim 1 wherein the search engine will handle a combination of the claims listed in claims 2, 3, and 4.

6. The preference-based search engine of claim 1 wherein the search engine will search for stops a designated distance from a designated point or distance along a specific route using our unique Point and Line Path Search algorithms.

7. The road trip planning application of claim 1 presents the search results produced by the preference-based search engine of claim 1 in a date, time and route sensitive itinerary format.

8. The road trip planning application of claim 1 can be accessed via the Web or via software on a local computer.

9. The road trip planning application of claim 1 will allow for of a wide variety of date, time and route sensitive marketing channels (coupons, specials, TripKits emails).
